(19) United States
(12) Patent Application Publication
(10) Pub. No.: US 2017/0164038 A1
(43) Pub. Date: Jun. 8, 2017

(54) ADVERTISEMENT PRESENTATION METHOD AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Weibo AO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,508

(22) Filed: Aug. 22, 2016

Related U.S. Application Data
(63) Continuation of application No. PCT/CN2016/089552, filed on Jul. 10, 2016.

(30) Foreign Application Priority Data
Dec. 8, 2015 (CN) 201510901776.5

(51) Int. Cl. H04N 21/431; H04N 21/488; H04N 21/435; H04N 21/81; H04N 21/472

(52) U.S. Cl. CPC H04N 21/4314; H04N 21/812; H04N 21/47217; H04N 21/435; H04N 21/4884

(57) ABSTRACT

Embodiments of the present disclosure provide an advertisement presentation method and electronic device for presenting an advertisement in a playback page of a video. The method includes: acquiring playback parameter information of the advertisement; parsing the playback parameter information to obtain playback time information and display area information of the advertisement in the video; and determining, according to the playback time information and the display area information, whether subtitle information in the playback page is covered by the advertisement, and if the subtitle information is covered by the advertisement, adjusting a display area of the advertisement such that the subtitle information is exhibited completely.

### CROSS REFERENCE TO RELATED APPLICATIONS

The present application is a continuation application of PCT application No. PCT/CN2016/089552 submitted on Jul. 10, 2016. This application is based upon and claims priority to Chinese Patent Application No. 201510901776.5, filed with the State Intellectual Property Office on Dec. 8, 2015, the entire contents of which are incorporated herein by reference.

### TECHNICAL FIELD

Embodiments of the present disclosure relate to multimedia content displaying technologies, and more particularly, to an advertisement presentation method and an electronic device.

### BACKGROUND

With the population of Internet multimedia technologies, watching online video content has gradually become a quite important part of work, study, entertainment, and life of people. As a result, advertising before video playback or during video playback also gradually becomes a common and important advertising form. Floating window advertising is one form of advertising during video playback. Generally, a current advertisement floating window is generally displayed in the lower right corner of an interface for watching a video by a user, and if a subtitle in the video is relatively long when an advertisement is displayed, a phenomenon in which the subtitle is covered by the advertisement floating window appears, which greatly affects normal watching of the video by the user.

### SUMMARY

The present disclosure is to provide an advertisement presentation method and an electronic device, to avoid a phenomenon in which a subtitle is covered by an advertisement floating window when an advertisement is presented in a playback page of a video, and to improve user experience.

According to a first aspect, an embodiment of the present disclosure provides an advertisement presentation method. The method is for presenting an advertisement in a playback page of a video, and includes: acquiring playback parameter information of the advertisement; parsing the playback parameter information to obtain playback time information and display area information of the advertisement in the video; and determining, according to the playback time information and the display area information, whether subtitle information in the playback page is covered by the advertisement, and if the subtitle information is covered by the advertisement, adjusting a display area of the advertisement such that the subtitle information is exhibited completely.

According to a second aspect, an embodiment of the present disclosure further provides a non-volatile computer storage medium, which stores computer executable instructions, wherein the computer executable instructions can be executed to perform any foregoing advertisement presentation method of the present disclosure.

According to a third aspect, an embodiment of the present disclosure further provides an electronic device, including: at least one processor; and a memory communicably connected with the at least one processor for storing instructions executable by the at least one processor, wherein execution of the instructions by the at least one processor causes the at least one processor to perform any above advertisement presentation method of the present disclosure.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart illustrating an advertisement presentation method according to Embodiment 1 of the present disclosure;

FIG. 2 is a logical block diagram illustrating an advertisement presentation apparatus according to Embodiment 2 of the present disclosure; and

FIG. 3 is a schematic structural diagram of an electronic device according to an embodiment of the present disclosure.

### DETAILED DESCRIPTION

A basic inventive concept of embodiments of the present disclosure is to provide a technical solution for advertisement presentation. Playback parameter information of an advertisement is acquired, the playback parameter information is further parsed to obtain corresponding playback time information and display area information of the advertisement in a video, and if it is determined, according to the playback time information and the display area information, that corresponding subtitle information in a playback page is covered by the advertisement, a display area is adjusted. In this way, the subtitle information is not covered by the display area of the advertisement, and the subtitle information is exhibited completely. Hence, user experience is greatly improved.

An advertisement presentation method and an electronic device according to exemplary embodiments of the present disclosure are described in detail hereinafter with reference to the accompanying drawings.

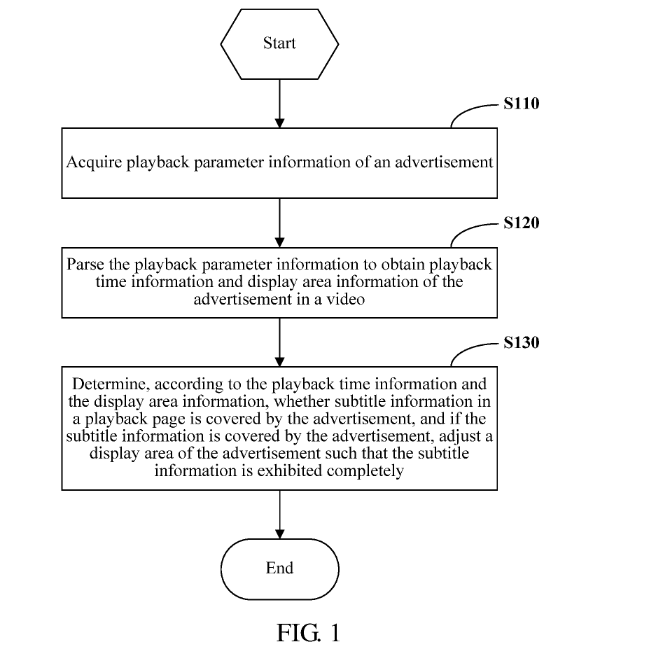

FIG. 1 is a flowchart illustrating an advertisement presentation method according to Embodiment 1 of the present disclosure. The method may be performed, for example, on a terminal device such as a smart phone or a pad. In the technical solution herein, a terminal device used as an enforcement object is taken as an example for description, and the terminal device is configured to present an advertisement in a playback page of a video.

Referring to FIG. 1, in step S110, playback parameter information of the advertisement is acquired.

In step S120, the playback parameter information is parsed to obtain playback time information and display area information of the advertisement in the video.

In a specific implementation manner, a terminal device generally sends an advertisement request to an advertisement server. In addition to receiving a content file (such as a picture or a video) related to an advertisement that is returned by the advertisement server, the terminal device further receives corresponding playback time information and display area information of the advertisement in a video that are returned by the server. It is to be noted that, the display area information may include: picture position coordinates, picture width, and picture height.

In step S130: Whether subtitle information in the playback page is covered by the advertisement is determined according to the playback time information and the display area information; and if the subtitle information is covered by the advertisement, a display area of the advertisement is adjusted such that the subtitle information is exhibited completely.

In practice, generally, a video server uses an existing subtitle parsing technology to perform subtitle parsing on all videos in a video database, defines subtitle information of each subtitle according to a video playback timeline, and stores parsed subtitle information in advance. Herein, the subtitle information may include: subtitle playback time, subtitle position coordinates, subtitle width, and subtitle height. The subtitle playback time is corresponding to starting and ending times on the video playback timeline. For example, subtitle information {300, 305, 40, 460, 800, 80} indicates that during 300 to 305 second on the video playback timeline, a subtitle appears in a position whose coordinates are (40, 460), subtitle width is 800, and subtitle height is 80. For another example, subtitle information {305, 308, 50, 460, 790, 80} indicates that during 305 to 308 second on the video playback timeline, a subtitle appears in a position whose coordinates are (50, 460), subtitle width is 790, and subtitle height is 80.

When the terminal device sends a video request carrying a video label to the video server, the video server searches the video database according to the video label, and returns a found video together with subtitle information to the terminal device. Thereby, the terminal device determines, according to the playback time information and the display area information that are obtained by parsing in step S120, whether corresponding subtitle information in the playback page of the video is covered by the advertisement.

If the subtitle information is covered by the advertisement, according to this exemplary embodiment of the present disclosure, the adjusting the display area of the advertisement such that the subtitle information is exhibited completely in step S130 may include: acquiring a covered area, corresponding to the playback time information of the advertisement, of the subtitle information; and adjusting the picture position coordinates of the advertisement according to the covered area, and/or adjusting the picture width of the advertisement, and/or adjusting the picture height of the advertisement.

Based on the adjusting the display area of the advertisement, the advertisement presentation method may further include: presenting the advertisement according to an adjusted display area.

In addition, when the subtitle is not covered by the advertisement, the advertisement is directly presented in the playback page of the video.

According to the advertisement presentation method provided in this embodiment of the present disclosure, playback parameter information of an advertisement is acquired, the playback parameter information is further parsed to obtain corresponding playback time information and display area information of the advertisement in a video, and whether subtitle information in a playback page is covered by the advertisement is determined according to the playback time information and the display area information, and if the subtitle information is covered by the advertisement, a display area is adjusted. In this way, the subtitle information is not covered by the display area of the advertisement when the advertisement is presented in the playback page of the video, and the subtitle information is exhibited completely. Hence, user experience is greatly improved.

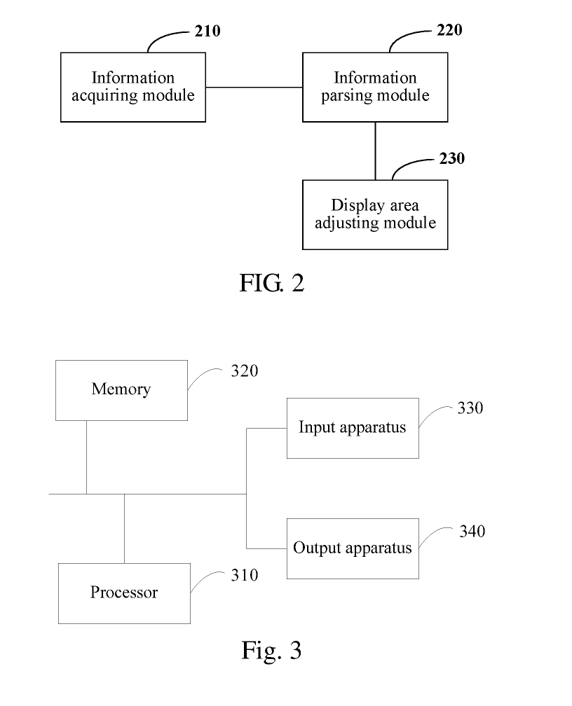

FIG. 2 is a logical block diagram illustrating an advertisement presentation apparatus according to Embodiment 2 of the present disclosure. The advertisement presentation apparatus may be configured to perform the steps in the method in the embodiment as illustrated in FIG. 1.

Referring to FIG. 2, the advertisement presentation apparatus includes an information acquiring module 210, an information parsing module 220, and a display area adjusting module 230. The information acquiring module 210, the information parsing module 220, and the display area adjusting module 230 are sequentially connected.

The information acquiring module 210 is configured to acquire playback parameter information of an advertisement.

The information parsing module 220 is configured to parse the playback parameter information to obtain playback time information and display area information of the advertisement in a video.

In an embodiment, the display area information includes: picture position coordinates, picture width, and picture height.

The display area adjusting module 230 is configured to: determine, according to the playback time information and the display area information, whether subtitle information in a playback page is covered by the advertisement, and if the subtitle information is covered by the advertisement, adjust a display area of the advertisement such that the subtitle information is exhibited completely.

In an embodiment, the subtitle information includes: subtitle playback time, subtitle position coordinates, subtitle width, and subtitle height.

According to the advertisement presentation apparatus provided in this embodiment of the present disclosure, playback parameter information of an advertisement is acquired, the playback parameter information is further parsed to obtain corresponding playback time information and display area information of the advertisement in a video, and whether subtitle information in a playback page is covered by the advertisement is determined according to the playback time information and the display area information, and if the subtitle information is covered by the advertisement, a display area is adjusted. In this way, the subtitle information is not covered by the display area of the advertisement when the advertisement is presented in the playback page of the video, and the subtitle information is exhibited completely. Hence, user experience is greatly improved.

To adjust the display area of the advertisement such that the display area does not cover a corresponding subtitle, specifically, the display area adjusting module 230 may be configured to: acquire a covered area, corresponding to the playback time information of the advertisement, of the subtitle information; and

adjust the picture position coordinates of the advertisement according to the covered area, and/or

adjust the picture width of the advertisement, and/or

adjust the picture height of the advertisement.

After the display area of the advertisement is adjusted, the advertisement presentation apparatus may further include: an advertisement presenting module (not shown in the figure), configured to present the advertisement according to an adjusted display area.

It is to be noted that, according to requirements of implementation, each part/step described in the present disclosure may be divided into more specific parts/steps, and two or more specific parts/steps or some operations of the components/steps may also be combined into a new generic part/step to achieve the objective of the embodiments of the present disclosure.

An embodiment of the present disclosure provides a non-volatile computer storage medium, which stores computer executable instructions, wherein the computer executable instructions can be executed to perform the advertisement presentation method disclosed in the above method embodiments.

FIG. 3 is a schematic structural diagram of hardware of an electronic device for executing the advertisement presentation method provided in the embodiment of the present disclosure. As shown in FIG. 3, the device includes: one or more processors 310 and a memory 320, wherein only one processor 310 is used as an example in FIG. 3.

The device for executing the advertisement presentation method may further include: an input apparatus 330 and an output apparatus 340.

The processor 310, the memory 320, the input apparatus 330, and the output apparatus 340 can be connected by means of a bus or in other manners. A connection by means of a bus is used as an example in FIG. 3.

As a non-volatile computer readable storage medium, the memory 320 can be used to store non-volatile software programs, non-volatile computer executable programs and modules, for example, program instructions/module (for example, the information acquisition module 210, the information parsing module 220, and the displaying area adjusting module 230 shown in FIG. 2) corresponding to the advertisement presentation method in the embodiments of the present disclosure. The processor 310 executes various functional applications and data processing of the server, that is, implements the advertisement presentation method of the foregoing method embodiments, by running the non-volatile software programs, instructions, and modules that are stored in the memory 320.

The memory 320 may include a program storage area and a data storage area, where the program storage area may store an operating system and an application that is needed by at least one function; the data storage area may store data created according to use of the processing apparatus for the advertisement presentation method, and the like. In addition, the memory 320 may include a high-speed random access memory, or may also include a non-volatile memory such as at least one disk storage device, flash storage device, or another non-volatile solid-state storage device. In some embodiments, the memory 320 optionally includes memories that are remotely disposed with respect to the processor 310, and the remote memories may be connected, via a network, to the processing apparatus for the advertisement presentation method. Examples of the foregoing network include but are not limited to: the Internet, an intranet, a local area network, a mobile communications network, or a combination thereof.

The input apparatus 330 can receive entered digits or character information, and generate key signal inputs relevant to user setting and functional control of the processing apparatus for the advertisement presentation method. The output apparatus 340 may include a display device, for example, a display screen.

The one or more modules are stored in the memory 320; when the one or more modules are executed by the one or more processors 310, the advertisement presentation method in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

What is claimed is:

1. An advertisement presentation method for presenting an advertisement in a playback page of a video, applied to a terminal, wherein the method comprises:
acquiring playback parameter information of the advertisement;
parsing the playback parameter information to obtain playback time information and display area information of the advertisement in the video; and
determining, according to the playback time information and the display area information, whether subtitle information in the playback page is covered by the advertisement, and if the subtitle information is covered by the advertisement, adjusting a display area of the advertisement such that the subtitle information is exhibited completely.

2. The method according to claim 1, wherein the display area information comprises: picture position coordinates, picture width, and picture height.

3. The method according to claim 2, wherein the adjusting the display area of the advertisement such that the subtitle information is exhibited completely comprises:
acquiring a covered area, corresponding to the playback time information of the advertisement, of the subtitle information; and
adjusting the picture position coordinates of the advertisement according to the covered area, and/or
adjusting the picture width of the advertisement, and/or
adjusting the picture height of the advertisement.

4. The method according to claim 1, wherein the subtitle information comprises: subtitle playback time, subtitle position coordinates, subtitle width, and subtitle height.

5. The method according to claim 1, further comprising: presenting the advertisement according to an adjusted display area.

6. A non-volatile computer storage medium storing computer executable instructions that, when executed by an electronic device, cause the electronic device to:
acquire playback parameter information of the advertisement;
parse the playback parameter information to obtain playback time information and display area information of the advertisement in the video; and
determine, according to the playback time information and the display area information, whether subtitle information in the playback page is covered by the advertisement, and if the subtitle information is covered by the advertisement, adjusting a display area of the advertisement so that the subtitle information is exhibited completely.

7. The non-volatile computer storage medium according to claim 6, wherein the display area information comprises: picture position coordinates, picture width, and picture height.

8. The non-volatile computer storage medium according to claim 7, wherein the adjusting the display area of the advertisement so that the subtitle information is exhibited completely the electronic device is caused to:
acquire a covered area, corresponding to the playback time information of the advertisement, of the subtitle information; and
adjust the picture position coordinates of the advertisement according to the covered area, and/or
adjust the picture width of the advertisement, and/or
adjust the picture height of the advertisement.

9. The non-volatile computer storage medium according to claim 6, wherein the subtitle information comprises: subtitle playback time, subtitle position coordinates, subtitle width, and subtitle height.

10. The non-volatile computer storage medium according to claim 6, wherein the electronic device is further caused to: present the advertisement according to an adjusted display area.

11. An electronic device, comprising:
at least one processor; and
a memory communicably communication with the at least one processor, wherein
the memory stores instructions executable by the at least one processor, wherein
execution of the instructions by the at least one processor causes the at least one processor to:
acquire playback parameter information of the advertisement;
parse the playback parameter information to obtain playback time information and display area information of the advertisement in the video; and
determine, according to the playback time information and the display area information, whether subtitle information in the playback page is covered by the advertisement, and if the subtitle information is covered by the advertisement, adjust a display area of the advertisement so that the subtitle information is exhibited completely.

12. The electronic device according to claim 11, wherein the display area information comprises: picture position coordinates, picture width, and picture height.

13. The electronic device according to claim 12, wherein the instructions to adjust the display area of the advertisement so that the subtitle information is exhibited completely cause the electronic device to:
acquire a covered area, corresponding to the playback time information of the advertisement, of the subtitle information; and
adjust the picture position coordinates of the advertisement according to the covered area, and/or
adjust the picture width of the advertisement, and/or
adjust the picture height of the advertisement.

14. The electronic device according to claim 11, wherein the subtitle information comprises: subtitle playback time, subtitle position coordinates, subtitle width, and subtitle height.

15. The electronic device according to claim 11, wherein the at least one processor is caused to: present the advertisement according to an adjusted display area.
